(19) United States
(12) Patent Application Publication
(10) Pub. No.: US 2019/0059245 A1
(43) Pub. Date: Feb. 28, 2019

(54) Process or method for eliminating or destroying a tropical disturbance, known as the High-low (Hilo) System of Tropical Disturbance Elimination

(71) Applicant: Michael Vincent Biondolillo, Harvey, LA (US)

(72) Inventor: Michael Vincent Biondolillo, Harvey, LA (US)

(21) Appl. No.: 13/865,007

(22) Filed: Apr. 17, 2013

Related U.S. Application Data
(63) Continuation of application No. 11/725,621, filed on Mar. 20, 2007, now abandoned.
(60) Provisional application No. 60/784,728, filed on Mar. 21, 2006.

(51) Int. Cl. A01G 15/00

(52) U.S. Cl. CPC A01G 15/00

(57) ABSTRACT

A method known as the High-Low System (HiLo) is disclosed as a process for destroying early-stage tropical disturbances and having the steps of establishing a Command Center, spraying cold water from large aircraft (High) and large ships (Low), and dispatching a wide array of jet aircraft at high altitude (Ultra High) emitting hot exhaust gases within the area of tropical disturbance. A preferred embodiment for this system includes dispatching roving fleets of ships during hurricane season, pre-positioning large cargo aircraft, pumping water from depths to obtain Fahrenheit temperatures of approximately 40 degrees for the High Phase and approximately 55 degrees for the Low Phase. The High and Low Phases aim to reduce air and surface water temperatures while the Ultra High Phase strives to reduce the sharp contrast of rising warm tropical air meeting the starkly contrasting cold upper atmosphere temperature.

### CROSS-REFERENCE TO RELATED APPLICATIONS

This is a continuation of U.S. patent application Ser. No. 11/725,621, filed on 20 Mar. 2007, which is a non-provisional of U.S. Provisional Patent Application Ser. No. 60/784,728, filed on Mar. 21, 2006, both of which are incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

This invention relates generally to the field of meteorological science and more specifically to a process or method for eliminating or destroying a tropical disturbance, known as the High-Low (HiLo) System of Tropical Disturbance Elimination.

Throughout known history, the world has endured the destructive effects of tropical storms, hurricanes, and typhoons. The ravages of these natural meteorological disasters have wreaked misery to humanity through untold loss of lives and property. In the midst of this tragic historical devastation, humanity has surely conjectured whether anything could be done to alleviate this misfortune. The High-Low System of Tropical Disturbance Elimination aims to do just that.

Inquiry into past technology, as well as empirical observation, indicate that there is no known process, system, or method in existence that can successful destroy or eliminate a tropical disturbance, storm, hurricane, or typhoon.

Research indicates that efforts to destroy tropical disturbances, hurricanes, or typhoons have been sparse or sketchy at best. In the 1950's there was an unsuccessful attempt to disburse silver iodide pellets from aircraft into clouds at high altitude in the area of tropical disturbance. More recently, in the aftermath of Hurricane Katrina, other theories and proposals have surfaced to postulate destroying tropical storms or hurricanes. These include coating the ocean with a polymer compound to cool the surface. Another speaks to using large jet engines to steer the hurricane. Yet another proposes using drilling rigs in the Gulf of Mexico. None have been successful to date.

The sparse efforts noted in the prior technology are deemed deficient because they all aim at destroying a full-blown hurricane or typhoon. The process or method outlined in this disclosure considers such efforts as utterly unrealistic due to the overwhelming destructive energy, force, and momentum that are intrinsic to these mature, advanced storms.

### BRIEF SUMMARY OF THE INVENTION

The primary object of the invention is to create a process for eliminating or destroying a tropical disturbance in its early stages, a goal that is presently not being attained in any form or fashion.

Another object of the invention is to pursue a proactive approach to eliminating tropical disturbances thereby saving lives and property.

Another object of the invention is to make use of already-existing or readily-modifiable equipment, components, and facilities, as well as a naturally-occurring substance—cold water at lower ocean depths.

A further object of the invention is to minimize development time and costs by maximizing use of “off-the-shelf” ships, aircraft, equipment, and components.

Yet another object of the invention is to provide the capability of ultimately developing ships, aircraft, equipment, and components from scratch to maximize the efficiency of the HiLo process.

Still yet another object of the invention is to provide a system that is environmentally friendly.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method or process, known as the High-Low (HiLo) System of Tropical Disturbance Elimination, for eliminating or destroying a tropical disturbance, comprising the steps of establishing and maintaining a command center; pre-positioning large cargo aircraft to spray cold water pumped from off-shore deep waters in the area of tropical disturbance (High Phase); pre-positioning into historical areas of tropical activity, roving fleets of ships that spray cold water pumped from lower ocean depths (Low Phase); and, dispatching by the command center, once a disturbance has been detected, a wide array of jet aircraft emitting hot exhaust gases at high altitude within the vertical and horizontal boundaries of the area of tropical disturbance Ultra High or Lagniappe Phase).

### BRIEF DESCRIPTION OF THE SEVERAL VIEWS OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a spray aircraft aloft in the High Phase. Two options are depicted.

FIG. 2 is a schematic diagram illustrating a typical cold water loading facility/airport in the High Phase.

FIG. 3a is a perspective view of the details of High Phase deepwater apparatus used to avoid ingestion of marine life and debris.

FIG. 3b is a perspective view of the details of an alternative to the deepwater apparatus used to avoid ingestion of marine life and debris in the High Phase.

FIG. 4a is an side elevation view of a Low Phase cold water spraying ship.

FIG. 4b is a frontal elevation view of a Low Phase cold water spraying ship.

FIG. 5A is frontal, side, and rear view of a spray ship's deepwater device used to avoid ingestion of marine life and debris in the Low Phase.

FIG. 5B is a rear view of an alternative to the FIG. 5A for avoiding ingestion of marine life and debris in the Low Phase. (Rear view is sufficient to convey concept.)

FIG. 6 is a schematic diagram depicting the Ultra High Phase (Lagniappe) operations.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The “High-Low System of Tropical Disturbance Elimination” (hereafter referred to as HiLo in this “DETAILED DESCRIPTION”), for which a patent is pursued, offers the following objectives and support for its uniqueness:
1. Prevent the development of a hurricane through aggressive intervention during the tropical disturbance early stages. This approach takes the position that destroying a full-blown hurricane is utterly unrealistic. Initial interest is in employing this unique system in the North Atlantic Region, including the Caribbean Sea and Gulf of Mexico. However, the HiLo System described and outlined in this application could be pursued in any region of the world plagued by tropical storms, hurricanes, or typhoons.
2. Employ existing “off-the-shelf,” or modified equipment, components and commodities in innovative and strategic ways. Not only will this approach hold costs down, it will help speed implementation of the HiLo System.
3. Should the system be adopted and prove successful, the intention is to adapt these systems and concepts into specially built equipment to serve the process even more effectively and efficiently.
4. This patent application predicates that, while tropical systems are complex formations, they are also considered fragile. Attacking any major component of the tropical disturbance offers the expectation that growth of the system can be subverted or eliminated.
5. Since the primary purpose of a patent application is to cover the invention itself, this application intentionally does not address cost, political, management, administrative, and intangible issues related to implementing the HiLo System. Also, in many instances, specific sizes of pumps, pipes, and etc. are intentionally omitted since they have no specific bearing on the unique overall system for which this application is being made. However, the applicant is fully prepared to discuss the specifics of these factors at the appropriate time.

### General Overview of HiLo:

The major thrust of HiLo is to attack and weaken the warm surface water of the system, as well as, the warm rising air that serve as key ingredients to the growth and strengthening of the depression into a tropical storm and, ultimately, into a hurricane. If these elements can be sufficiently weakened, there is a strong likelihood that the tropical disturbance will self-destruct and dissipate into a powerless state. The thinking here is that a tropical disturbance . . . even though it is a complicated entity . . . can possibly be destroyed if its developing environment that would ordinarily permit it to grow into a full-blown hurricane, can be interdicted long enough until other weather patterns can eventually permanently thwart the tropical disturbance's development.

This weakening can be achieved by using an UNLIMITED, COST-FREE, and ENVIRONMENTALLY-FRIENDLY commodity—very cold water that exists at lower ocean depths.

The HiLo System incorporates three phases: High Phase, Low Phase, and Ultra-High (Lagniappe) Phase.

### High Phase:

The goal of this HiLo phase is to “buy time” by mitigating the escalation of the tropical disturbance through rapid deployment of very large cargo aircraft each outfitted with:
1. A large rubber bladder(s) or metal tank(s) holding the maximum volume of cold water allowable within the aircraft's load and balance limitations.
2. A Hose(s) extending from the water tanks to the aircraft aerial spray system.
3. An aircraft aerial spray system. Note: Another option to hold down costs and to minimize aircraft modifications (which may not be permitted on leased aircraft) is to pump water through nozzles attached to the water tank hoses, and exiting on each side of the front and rear of the aircraft at high velocity in a manner similar to a lawn sprinkler. Available aircraft ports can be used to allow nozzles to protrude through the aircraft to emit high-velocity spray.
4. Electric, hydraulic, or other non-carbon monoxide-producing motor/engine(s) to pump water from the tanks to the aerial spray tubes and/or spray nozzles. The powerful pumps currently used on KC-135 and KC-10 refueling aircraft offer one excellent source for use in cold-water spray aircraft.

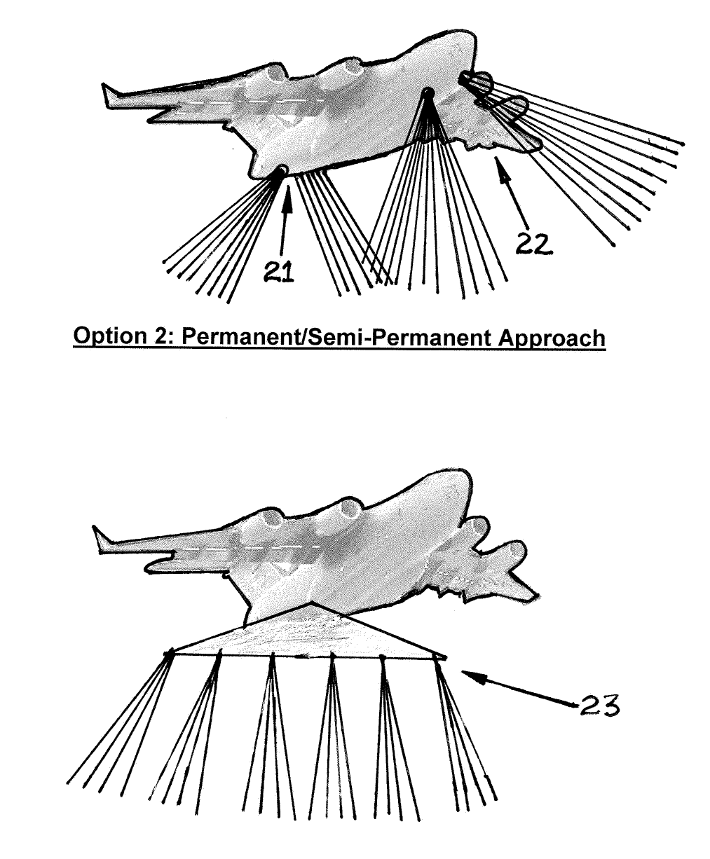

FIG. 1 depicts two options of the cold-water spray aircraft. Option 1 shows a standard aircraft improvised with front (22) and rear (21) spray tubes/nozzles exiting through modified aircraft doors, cargo doors, or other portals.

Option 2 offers a winglet either permanently or semi permanently installed onto the aircraft. A large hose(s) would lead from the bladder(s)/tanks(s) inside the aircraft to the winglet. Spray nozzles would be fitted along the winglet to provide uniform dissemination of cold-water spray. The winglet would be positioned to prevent the hot jet engine exhaust from warming the exiting cold-water spray. Fitting a semi-permanent winglet would offer the opportunity to use aircraft for other purposes during the non-tropical season.

Each aircraft will spray cold water at an altitude of approximately 10,000 feet where the temperature is colder than at lower altitudes. Since temperature is a dynamic factor, aircraft altitude adjustment may be called for based upon temperatures at varying altitudes in the tropical disturbance area. This altitude regime also simplifies the process by eliminating the need to pressurize the aircraft. Operating at this relatively low altitude also means that aircraft can arrive “on-line” sooner, and thus start discharging their cold water.

Due to the hot jet engine exhaust temperatures, HiLo aircraft cannot be deployed to very low altitudes. It is hypothesized that these hot exhaust temperatures would serve to aggravate the warm ocean surface temperatures and rising warm, moist tropical air.

Another important positive ingredient stems from the fact that the hot jet exhausts help reduce the cold temperatures that exist at even this relatively low operating altitude. This cold-temperature reduction is important by helping reduce the temperature contrast of rising warm air meeting the cold upper air.

Since such a system as HiLo has never been employed, there is no historical or empirical data that would substantiate the number of aircraft that should be dispatched. Initially it is expected that a minimum of twenty-four very large aircraft would be pre-deployed in two contingents of twelve aircraft each to two locations statistically/historically determined as being in the vicinity where there is the greatest likelihood of tropical disturbance development. Of course, using more aircraft would be more effective.

Pre-deployment of these water spray-fitted cargo aircraft would be to at least two sites (minimum of twelve aircraft (or more if funding permits) at each site in the general vicinity where greatest tropical activity has occurred historically; and, having a runway capable of accommodating large cargo aircraft such as, but not limited to, the C-5 “Galaxy,” C-17 “Globemaster III,” or Boeing 747 cargo version.

Two suggested sites for the North Atlantic Hurricane Region are:
Cape Verde/Canary Islands/Azores
Caribbean area such as the former Roosevelt Roads Naval Air Station

Having two sites increases the prospects that the aircraft would be relatively close to the area of tropical disturbance origination . . . thus reducing the time of travel by the aircraft to the area of disturbance.

It is important to note that once a tropical disturbance has been detected all aircraft will be dispatched to the vicinity for the two (or more) sites. Note: Simultaneous tropical disturbances are discussed later.

Cold water would be obtained from the extreme ocean depth depths. The aircraft would be loaded with water from large-diameter hoses extending from the aircraft loading facility near the airport runway with hose(s) running to the appropriate ocean depth to capture the cold water. Carbon-based fuel or electric motors would pump the cold water into each aircraft.

Since drag induced by the large-diameter hose is NOT a factor for the High Phase, colder water can be secured from lower depths sufficient to obtain water of approximately 40 degrees Fahrenheit.

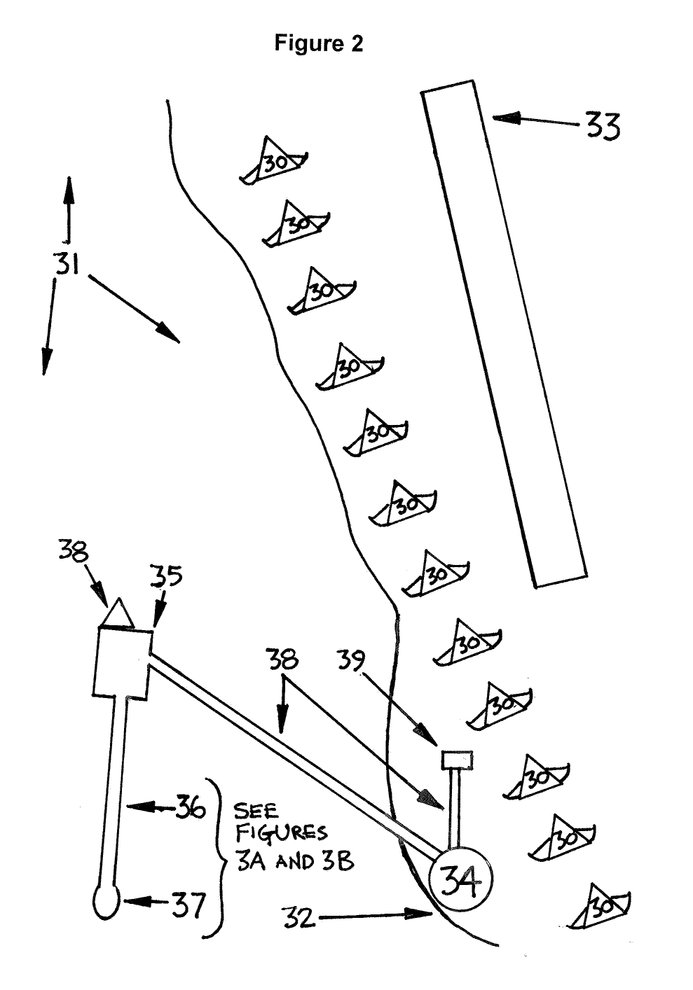

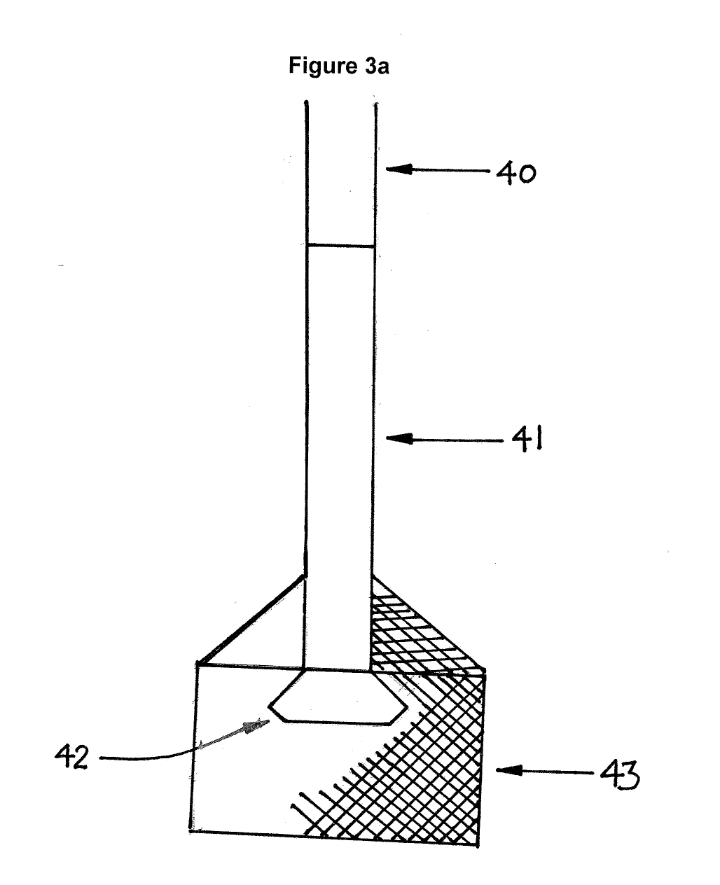

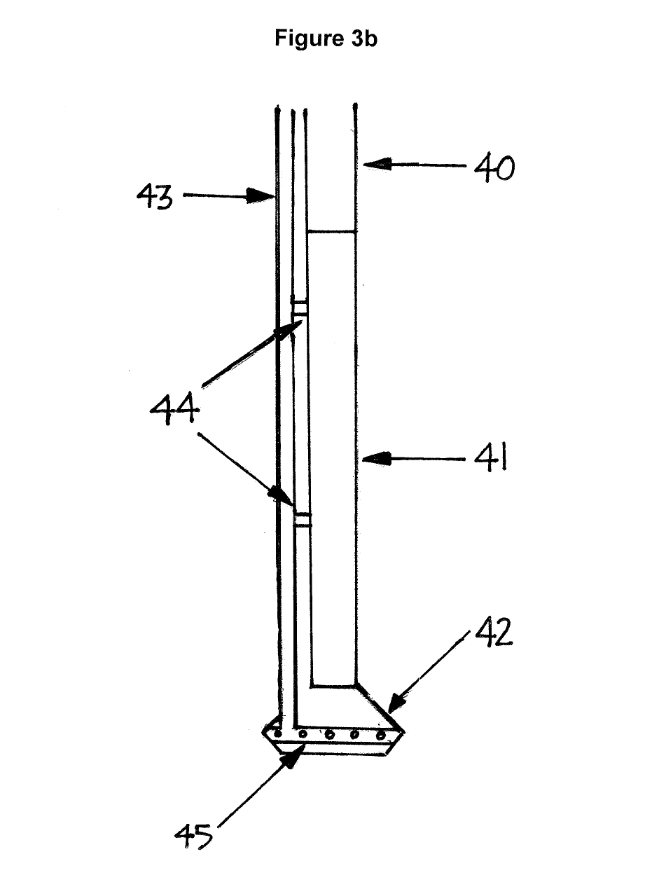

See FIGS. 2, 3a, and 3b. FIG. 2 gives a schematic layout of a typical cold-water pumping/water loading/airport facility, including the airport facility (32), relatively near the ocean (open sea) (31), with a runway(s) (33) and waiting large cargo aircraft (30). Water is supplied to the facility from an offshore pumping platform or pumping ship (35), with cold water pumped (38) from the deep ocean depths via round/oval/triangular, etc. metal, composite, etc. pipe (36) capable of withstanding deep ocean pressures. The cold water enters the piping by way of a module (37), described in greater detail in FIGS. 3a and 3b. Metal, composite, etc. pipe (38) takes the water to the onshore-insulated holding tank (34). From that point, it is pumped (39) by metal, composite, etc. pipe (38) into each aircraft (30). Flow from the offshore platform/ship pump (38) into the tank (34) and aircraft is regulated by flow gauges at both pumps to prevent under or over fill of the bladders or tanks. Loading the water into the aircraft would be similar to pumping fuel into aircraft at a very rapid rate.

FIGS. 3a and 3b deal with a particularly crucial facet of pumping at high rates from the deep ocean—namely high pressure and potential interference from marine life and debris. In FIG. 3a, the pump pipe (40)(41) is fed by a large inlet orifice (42), which is protected by the screened grid box (43) to prevent ingestion of marine life and debris as the water is pumped at high rates. Note: Only a portion of the screen is shown in 43 in order to avoid drawing clutter.

FIG. 3b offers an alternative to FIG. 3a. The major difference is that compressed air is pumped from the platform/ship down a high-pressure tube (43) attached to the water pipe (40)(41) to tubing fitted with compressed air jets (45) ringed around the water inlet orifice (42). The job of the compressed air is to repel marine life and debris away from the water inlet orifice.

All components are constructed to withstand the high ocean pressures at pumping depth. As pressure reaches extreme levels, it may be necessary to transition to heavier, triangular, or other configuration (41) to withstand the pressure.

Potentially, each platform/pumping ship could be fitted with more than one pump and pumping pipe depending on volume needed.

Once the National Hurricane Center has detected a tropical disturbance, cold water would be loaded onto all available aircraft. Immediately upon loading water, each aircraft would be dispatched to the area of concern to disperse its cold-water cargo. Once all safety check and weigh and balance calculations are cleared by the aircraft loadmaster, the aircraft would take off in flights of four aircraft, joining up en route into a line-abreast formation flying to and within the coordinates of the tropical disturbance as directed by National Hurricane Center or U.S. Satellite Agency staff.

Upon reaching the determined coordinates, each line-abreast formation would discharge its cold-water cargo, preferably in a spray pattern, and return to the nearest of the two reload facilities for cold water re-supply and return to the tropical disturbance area.

The aircraft would continue to drop cold-water cargo at least until the HiLo Low Phase resources arrive in the tropical disturbance area. Ideally, aircraft would continue to augment HiLo Low Phase operations as long as resources and tropical system development permitted.

The falling cold water would work to offset the rising warm air and would help cool the water temperature as the falling water reaches the ocean surface and intermixes and disperses throughout the water in the area. Keep in mind that the main focus of the High Phase is to stall strengthening of the tropical system until the Low phase can operate at full force.

### Low Phase:

This phase represents a major component of the HiLo System in abating a tropical disturbance.

Throughout the Atlantic Hurricane Season, specially fitted ships would be pre-deployed on patrol in areas of the Atlantic Ocean and Caribbean Sea to general areas where historically there is the greatest likelihood of tropical disturbance development. The same principle could apply in other parts of the world.

The ships would be capable of spraying cold water from the depths of the ocean waters. This cold water would be sprayed from the ships as they navigate at their top speed traversing the warm tropical waters within the tropical disturbance boundaries. The very cold water would intermix and disperse within the warm tropical waters, thereby lowering the overall surface temperature and depriving the tropical disturbance of one of its main growth ingredients.

Ideally, ships would continually spray throughout the hurricane season. This not only maintains readiness and functionality of the pump system, but spraying cold water could conceivably retard tropical disturbance growth. However, this feature is not critical to the overall HiLo system.

Immediately upon notification of a tropical disturbance formation, HiLo ships would head to coordinates of the developing disturbance as directed by the Command Center—unless, of course, the ship is already operating in the tropical area of interest—in which case the ship(s) would continue spraying cold water and maintain course as directed.

Travel time to the disturbance would be minimized since the ships have already been deployed into the general area throughout the Atlantic Hurricane Season. Cold water spraying would resume once a ship has reached the area in question, if in fact it had been spraying while on patrol. If possible, all ships would conduct cold-water spraying operations when on general assignment to maintain proficiency.

As with the aircraft, since HiLo has never been employed, there is no historical or empirical data that would substantiate the number of ships that should be dispatched. Variables such as size, speed, and power would impact the number of ships required, but a rough estimate is that at least 50 ships would be needed.

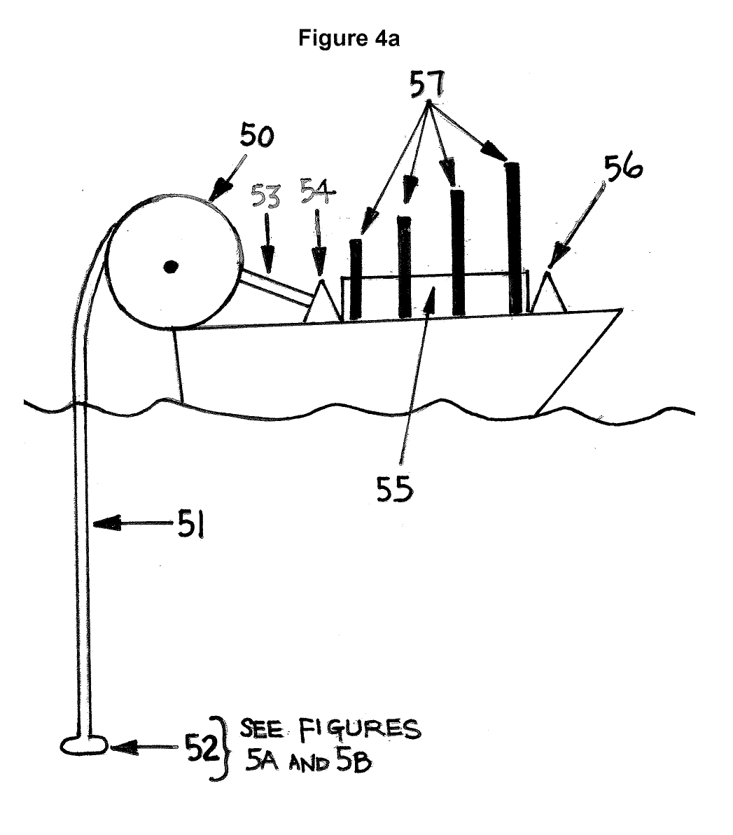

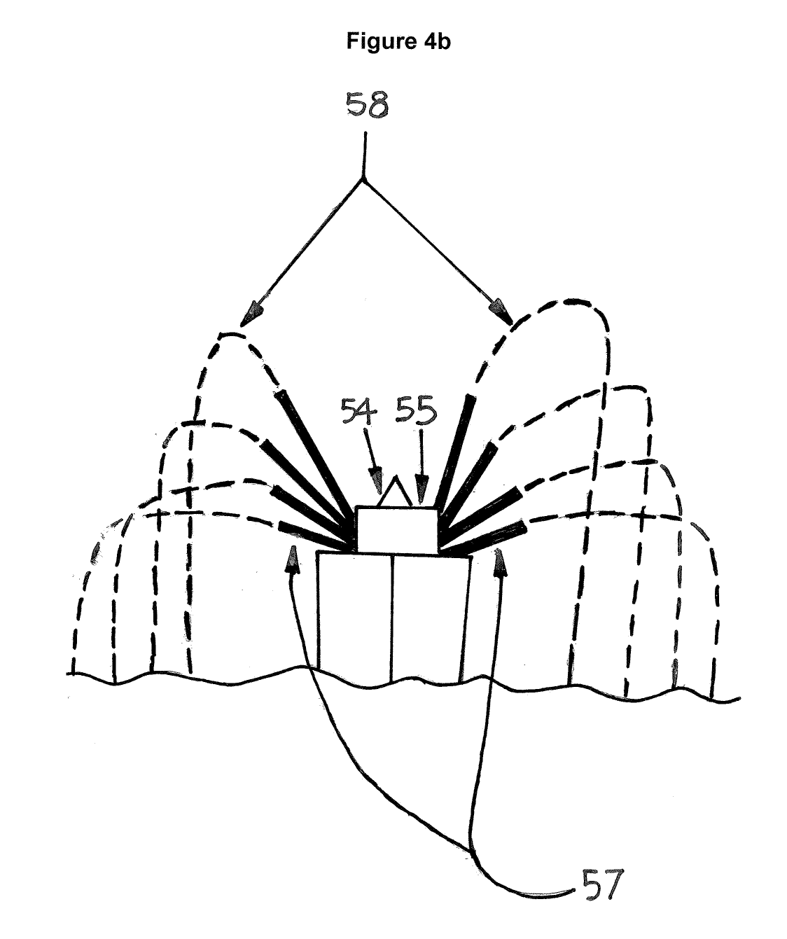

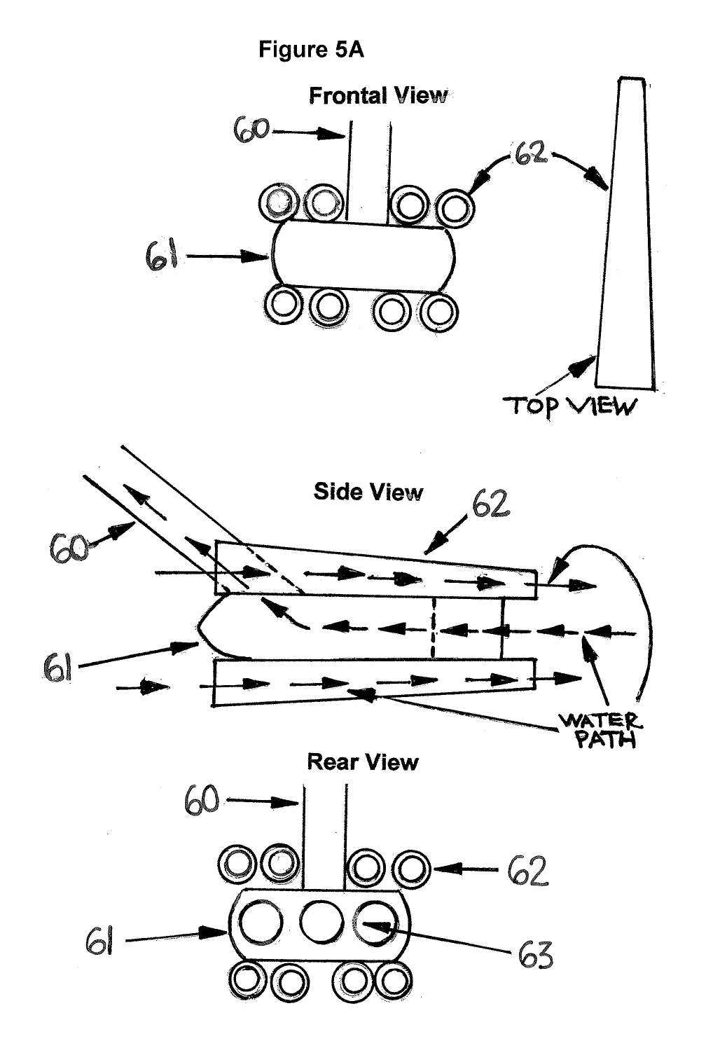

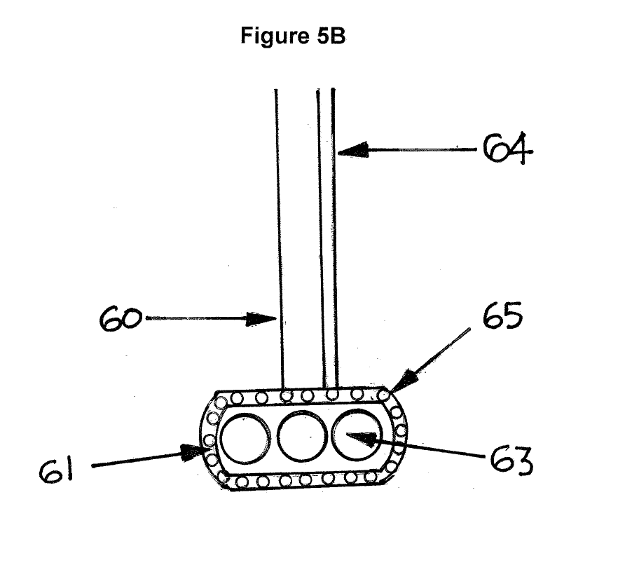

Virtually any type of military or civilian ship could be employed that permits configuration as described in FIGS. 4a, 4b, 5a, and 5b. This is one type of configuration. Other similar configurations could be used in the HiLo System to pump water from the colder depths, temporarily store the cold water in bladders or tanks on the ships, and to optimize the ocean surface area covered by the spray pattern generated from the water-holding bladders or water tanks on the ships.

See FIGS. 4a and 4b. These drawings show the components of a typical spray ship configuration. In preparation for spraying, a large horizontal or vertical reel (50) lowers a large-diameter or triangular flexible, pressure-resistant hose (51) into the ocean to a depth where water approximately 55 degrees Fahrenheit can be obtained.

Water is pulled into the water inlet orifice of the module (52) by force of the pump (54) located on the ship, through metal, composite, etc. pipe (53) into the holding bladders or tanks (55) on the ship. Then, the second pump (56) forces the water into the spray pipes fitted with nozzles (57). The end result is the spray pattern shown at 58 in FIG. 4b. Varying the angle of the spray pipes, as well as the pump pressure (more than one pump can be used at 56) produces the wide breadth of spray patterns shown in FIG. 4b. The flow of water throughout the system is regulated by flow gauges at both pumps to prevent under or over fill of the bladders or tanks.

Important Note: The module (52) must be heavily weighted-down so that it remains at depth when the ship when in pumping and spraying mode is pulling it.

See FIGS. 5a and 5b, which describe the crucial module (61) in greater detail. High pressure at pumping depth and interference from marine life and debris pose a potential dilemma to the success of the HiLo System, similar to the problem outlined earlier in the High Phase.

FIG. 5a presents one means for addressing this issue. It shows the module (61) with its water inlet orifices (63). The flexible hose (60) takes the water up to the ship by force of the ship's pump(s). A unique feature of the module in this configuration is the adaptation of eight rigid metal tapered tubes welded to the module body. As the module (61) is being pulled by the ship via the connecting hose (60), water enters the tapered tube through the wider opening and exits through the smaller rear outlet—at much higher velocity and force. The force of this water exiting from the eight tapered tubes is expected to repel marine life and debris thus keeping it from entering the water inlet orifices (63)

FIG. 5b offers an alternative to FIG. 5a. The major difference is that instead of the tapered tubes, compressed air is pumped from the platform/ship down a high-pressure tube (64) attached to the water hose (60) to metal tubing fitted with compressed air jets (65) ringed around the rear of the module (61). The job of the compressed air is to repel marine life and debris away from the water inlet orifices (63).

All components in FIGS. 5a and 5b will be constructed to withstand the high ocean pressures at pumping depth.

The main characteristic of the Low Phase, as in the High Phase, features pumping and spraying cold water that will intermix with the warm/hot surface water, thus lowering the surface temperature. Also, those water spray paths that are higher into the sky, will serve to cool the warm rising tropical air.

Depths to obtain this water will vary depending on the area of the ocean being traversed. However, the minimum depth necessary to obtain water of approximately 55 degrees Fahrenheit will be used so as to minimize the drag of the large-diameter hose(s) on each ship's speed, or to prevent hose collapse due to water pressure at lower depths.

Speed, size and power are important factors—first choice would be given to available ships with the greatest speed and size—yet still highly capable of towing the drag-inducing submerged hose when in cold-water spraying mode. Surplus aircraft carriers and oil tankers would be ideal owing to their size and speed.

It is estimated that spray ships could generate spray patterns from one to ten miles in breadth, or more, depending on the size of ships in use. Also, it is possible that some spray ships could be fitted with more than one pump, pumping hose, and more spray tube/nozzle groupings as allowed by the size of the ship.

It is important that ships maintain heading as directed by the HiLo Command Center. The command center will strive to direct ships to coordinates within the tropical disturbance area that are constantly changing—the goal being to cover different areas so that the cold-water spray is disseminated as broadly as possible within the assigned area.

### Ultra High Phase (“Lagniappe” Phase):

Recently the U.S. Navy retired the last two squadrons of Northrop-Grumman F-14 “Tomcats” and placed them in storage for possible future use. They, along with numerous surplus aircraft are housed at the Air Maintenance and Regeneration Center (AMARC) in Arizona. Consideration should be given to using powerful, swift aircraft such as the F-14, to augment the HiLo System. Each of these aircraft is equipped with two powerful engines with afterburner abilities. Simply flying these aircraft at high altitude within the boundaries of the developing tropical disturbance, emitting their hot exhaust gases, would reduce the cold air temperature.

Reducing the dissimilarity between the temperatures of warm rising air as it meets the cold temperature at high altitude (within the boundaries of the tropical disturbance), would serve to diminish further development of the tropical disturbance. It is considered that the warm rising tropical air meeting the cold air at higher altitudes is one of the factors that causing the ultimate rotational characteristic as the tropical disturbance grows. If the cold air can be sufficiently warmed, the growth can be impeded.

Maintenance time and cost on any surplus military aircraft used for HiLo would be significantly reduced since combat and armament systems could be eliminated.

Any high-performance single or multi-engine military or civilian aircraft would be acceptable. They could be dispatched for virtually any location in the region and, thanks to their speed, could quickly arrive in the area of tropical disturbance. The military fighter-type could remain in region virtually indefinitely; weather permitting, if refueling tanker aircraft are kept in the vicinity.

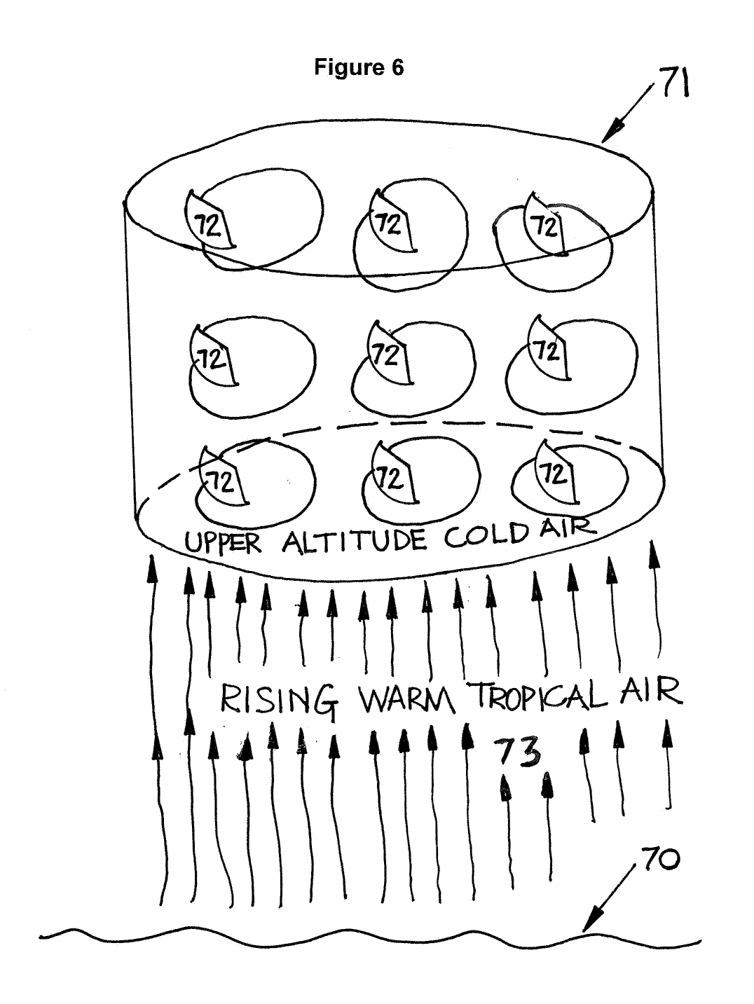

See FIG. 6. This schematic representation of the Ultra High Phase shows the warm ocean surface (70) with the warm tropical air (73) rising to meet upper cold air (71) within the area of tropical disturbance. Only nine aircraft (72) are shown with their schematic flight paths. In reality, use of many more aircraft would be beneficial in achieving the desired result.

### Other Considerations:

1. Satellite Guidance—While discussed in earlier sections, the following point bears repeating: The National Hurricane Center or other satellite tracking resources would dispatch aircraft and ships to the longitude and latitude coordinates of the tropical disturbance, with priority given to the areas with the warmest water temperature readings within the tropical disturbances. This guidance to and within the tropical disturbance should be relatively straightforward thanks to precise satellite guidance and meteorological tracking aircraft with their temperature-reading capabilities.
2. Safety Issues—Safety of all HiLo personnel is paramount. Close monitoring and feedback of HiLo results by “on-station” personnel to command headquarters will result in an ultimate determination concerning the effectiveness of HiLo operations. Should there come a point where tropical conditions fail to abate, and conditions render air and sea operations unsafe, all aircraft and ships will be removed from the storm ASAP.
3. Simultaneous Tropical Disturbances—The position and brevity of this issue is not intended to diminish its critical importance. Two or more tropical disturbances may appear at the same time. This would call for splitting resources or, if it can be reasonably be determined by Command Center personnel, the tropical disturbance having the greater likelihood—based on steering currents and weather systems—of reaching land or the most populated area should be addressed.
4. General—HiLo offers a positive system to eliminate tropical disturbances before their growth into hurricanes. It's potential for success is limited only by the resources applied. Adjustments to the number of aircraft and ships required will be necessary as operational data is gathered after HiLo is engaged. HiLo, as presented here, aims to use existing materiel. Should this system prove to be successful, more permanent modifications to aircraft and ships would serve to further enhance HiLo's effectiveness.

Also, funding may limit the pre-positioning of aircraft to only one site in the area of greatest statistical probability for tropical disturbance development.

This patent application, covering “The High-Low (HiLo) System of Tropical Disturbance Elimination,” seeks to patent the system that contains the following unique features:
1. Use of very cold water at the lower ocean depths to spray onto the ocean/sea surface of the area of tropical disturbance.
2. Pre-positioning large cargo spray aircraft at locations in the general area where historical/statistical data indicate the greater likelihood of tropical disturbance formation.
3. Placing a large fleet of cold-water spraying ships on patrol in the general area(s) where historical/statistical data indicate the greater likelihood of tropical disturbance formation.
4. Employ high-performance aircraft, preferably with afterburners, to patrol the upper atmosphere within the area of tropical disturbance.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for reducing the intensity of a tropical disturbance comprising the steps of:
A. establishing a Command Center to administer the method;
B. re-positioning cold-water spray ships during Atlantic Hurricane Season (June 1 through November 30) into areas historically and statistically most likely to spawn tropical storms;
C. pre-positioning large cargo aircraft at two or more sites in the Atlantic Region such as the Cape Verde Islands and Puerto Rico;
D. pumping water from depths to obtain water at a temperature of less than approximately 40 degrees Fahrenheit using offshore water-pumping platforms or static ships and piping the cold water by high-pressure pumps to waiting aircraft;
E. spraying the cold water from bladder(s) or tank(s) housed in large cargo aircraft;
F. pumping water from a depth to obtain water at a temperature of less than approximately 55 degrees Fahrenheit;
G. spraying the cold water from a fleet of ships spraying in a pattern of approximately one mile to approximately 10 miles, or more, in breadth, depending on the size of the ship, wherein the cold water is sprayed into the air and falls onto the ocean surface;
H. dispatching a wide array of jet aircraft from available locations when called for by the Command Center; and
I. emitting hot jet exhaust gases from powerful, swift jet aircraft operating at altitudes of 15,000 to 45,000 feet within the bounds of the area of tropical disturbance.

2. A method for reducing the intensity of a tropical disturbance comprising the steps of:
A. establishing a Command Center to administer the method;
B. re-positioning cold-water spray ships into areas historically and statistically most likely to spawn tropical storms;
C. pre-positioning large cargo aircraft at one or more sites;
D. pumping water-from depths to obtain water at a temperature of less than the surface temperature of the ocean using offshore water-pumping platforms or static ships and piping the cold water by high-pressure pumps to waiting aircraft;
E. spraying the cold water from bladder(s) or tank(s) housed in large cargo aircraft;
F. spraying the cold water from a fleet of ships spraying in a pattern of approximately one mile to approximately 10 miles, or more, in breadth, depending on the size of the ship, wherein the cold water is sprayed into the air and falls onto the ocean surface;
G. dispatching a wide array of jet aircraft from available when called for by the Command Center; and
H. emitting hot jet exhaust gases from powerful, swift jet aircraft operating at altitudes of 15,000 to 45,000 feet within the bounds of the area of tropical disturbance.

3. The method of claim 2, wherein the cold-water spray ships are repositioned during Atlantic Hurricane Season (June 1 through November 30).

4. The method of claim 2, wherein the large cargo aircraft are pre-positioned in the Atlantic Region at sites such as the Cape Verde Islands and Puerto Rico.

5. The method of claim 2, wherein water is pumped from depths to obtain water at a temperature of less than approximately 40 degrees Fahrenheit.

6. The method of claim 2, wherein water is pumped from depths to obtain water at a temperature of less than approximately 55 degrees Fahrenheit.

7. A method of retarding the development of a tropical disturbance comprising the steps of:
A. establishing a Command Center to administer the method;
B. re-positioning cold-water spray ships during Atlantic Hurricane Season (June 1 through November 30) into areas historically and statistically most likely to spawn tropical storms;
C. pre-positioning large cargo aircraft at two or more sites in the Atlantic Region such as the Cape Verde Islands and Puerto Rico;
D. pumping water from depths to obtain water at a temperature of less than approximately 40 degrees Fahrenheit using offshore water-pumping platforms or static ships and piping the cold water by high-pressure pumps to waiting aircraft;
E. spraying the cold water from bladder(s) or tank(s) housed in large cargo aircraft;
F. pumping water from a depth to obtain water at a temperature of less than approximately 55 degrees Fahrenheit;
G. spraying the cold water from a fleet of ships spraying in a pattern of approximately one mile to approximately 10 miles, or more, in breadth, depending on the size of the ship, wherein the cold water is sprayed into the air and falls onto the ocean surface;
H. dispatching a wide array of jet aircraft from available locations when called for by the Command Center; and
I. emitting hot jet exhaust gases from powerful, swift jet aircraft operating at altitudes of 15,000 to 45,000 feet within the bounds of the area of tropical disturbance.
